(19) United States
(12) Patent Application Publication
(10) Pub. No.: US 2007/0025441 A1
(43) Pub. Date: Feb. 1, 2007

(54) Method, module, device and system for rate control provision for video encoders capable of variable bit rate encoding

(75) Inventors: Kemal Ugur, Tampere (FI); Jani Lainema, Tampere (FI); Yuxin Zoe Liu, Irving, TX (US)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/194,068

(22) Filed: Jul. 28, 2005

(51) Int. Cl. H04N 11/04

(52) U.S. Cl. 375/240.03; 375/240.24

(57) ABSTRACT

In general, a methodology of rate control for a video encoding is provided, which is implementable by the means of a method, a device, a computer program and/or a video encoder. A frame encoding process is performed for each frame in that an initial quantization parameter is calculated for being used as a quantization parameter for encoding a current frame. Each group of macroblocks within the current frame is encoded group by group; i.e. group-wise. A score value is determined after macroblock encoding of a current group of macroblocks. In case the score value exceeds a pre-defined threshold, the quantization parameter for encoding the next group of macroblocks is adjusted; otherwise, the macroblock encoding is continued with the quantization parameter which is currently used for encoding the current group of macroblocks.

### BACKGROUND OF THE INVENTION

The present invention relates to rate controllers for video encoders. In particular, the present invention relates to video encoders capable for generating compressed video bitstreams, which video encoders are configurable to comply with a pre-defined target bit rate within specified bit rate variations.

Most practical video transmission technologies require the encoded/compressed video bitstream to adhere to restrictions in terms of average bit rate and bit rate variations. The bit rate variations normally address buffering requirements. All current video compression standards (video codecs) contain, normatively or informatively, a buffering model, which rate control scheme of a video encoder needs to fulfill, so as to form a compliant bitstream.

3GPP (3^{rd} Generation Partnership Project) currently considers to require a certain minimum quality level for all production video encoders. Rate control schemes for 3GPP terminal-based video encoders need to be reasonably lightweight in terms of cycles and memory consumption, flexible in terms of buffering requirements so to be able to cope with the constraints of the different applications of a 3GPP terminal-based encoder (e-g—recording, streaming service, and conversational applications), and of high quality so to improve the user experience. Most importantly, such video encoders need to fulfill the buffering requirements set by the standards at all times to ensure compliant bit streams and hence interoperability. For conversational applications, the end-to-end delay requirement is very low which means the rate control scheme should work on very tight buffer levels.

Although there are no fewer than thirty known different rate control schemes, none of these schemes meet all of the above-identified requirements, namely being light-weight, essentially single-pass, flexible in terms of applications, and strict enough to guarantee compliance with the buffering schemes of the video coding standards relevant to 3GPP (e.g., H.263 baseline, H.246, MPEG-4 part 2 simple profile, and AVC baseline standards.)

### BRIEF SUMMARY OF THE INVENTION

The present invention addresses the above-identified issues by providing a rate controller for compressed video encoders. The controller of the present invention can be configured to comply with the buffering schemes specified in current video-coding standards. In particular, the present invention solves the problem of controlling the bit rate of the video at tighter buffer levels (e.g. less than 1 sec).

In accordance with a first aspect of the present invention, a method of rate control for a video encoder is provided. A frame encoding process is performed for each frame in that an initial quantization parameter is calculated for being used as a quantization parameter for encoding a current frame. Each group of macroblocks within the current frame is encoded group by group; i.e. group-wise. A score value is determined after macroblock encoding of a current group of macroblocks. In case the score value exceeds a pre-defined threshold, the quantization parameter for encoding the next group of macroblocks is adjusted; otherwise, the macroblock encoding is continued with the quantization parameter, which is currently used for encoding the current group of macroblocks.

According to an embodiment of the present invention, the score value is determined on the basis of at least one out of the group comprising one or more bit envelope values for the current frame, a predictive number of bits, which predicts a number of bits required for encoding the current macroblock at the time of encoding, and a macroblock index.

According to an embodiment of the present invention, the predictive number of bits is determined on the basis of the number of bits generated for encoding one or more previous macroblocks of the current frame and/or one or more one or more previous macroblocks of one or more previous frames.

According to an embodiment of the present invention, the bit envelope values are determined for the current frame. The bit envelope values include at least an upper limit and a lower limit and are determined in accordance with a buffer model and are preferably based on at least one value out of the group comprising a video bit rate, a target number of bits for the current frame and a video frame rate. The score value is determined on the basis of the predictive number of bits, the envelope values, and a pre-defined function to account for unreliability of the bit prediction, which is a function of said macroblock index. The pre-defined function is preferably a parabolic function implementable on the basis of a look-up table. According to an embodiment of the present invention, the adjusting of the quantization parameter comprises offsetting the quantization parameter by at least one offset value. The at least one offset value is preferably dependent on the envelope values and/or the determined predictive number of bits.

According to an embodiment of the present invention, the adjusting of the quantization parameter is performed in dependence of the score value.

According to an embodiment of the present invention, at least one rate control-related parameter is initialized before frame encoding. The at least one rate control-related parameter is selected from the group including bit rate and buffer size.

According to an embodiment of the present invention, a number of macroblocks is determined, which have been encoded since the last quantization parameter adjustment has taken place. In case the number of macroblock exceeds a pre-defined threshold, the adjustment of the quantization parameter is allowed. Otherwise, the quantization parameter is maintained.

According to an embodiment of the present invention, if necessary, an updated initial quantization parameter is determined for the current frame and the frame encoding process is repeated on the basis of the updated initial quantization parameter.

According to an embodiment of the present invention, it is determined whether the current frame is a P frame or an ideal data representation frame.

According to an embodiment of the present invention, if the current frame is a P-frame, the predictive number of bits is determined from a bit distribution of one or more previous frames.

According to an embodiment of the present invention, if the current frame is an ideal data representation frame, the predictive number of bits is determined from the number of bits generated at a previous frame.

According to an embodiment of the present invention, if the current frame is a P frame, the initial quantization parameter is calculated by calculating values for short window and long window quantization parameters; calculating the initial quantization parameter based upon the short window and long window quantization parameters; and clipping the value for the frame's initial quantization parameter.

According to an embodiment of the present invention, if the current frame is an ideal data representation frame, the initial quantization parameter is calculated in accordance with the following decisions. If a buffer availability check in accordance with the buffer model is successful, a quantization parameter of the previous P-frame is employed as the initial quantization parameter. If the buffer availability check fails, the initial quantization parameter is extrapolated from the number of bits generated for one or more previous frames and the quantization parameters used for encoding the one or more previous frames and the extrapolated quantization parameter are clipped. The extrapolation is preferably based on a regression calculation on the basis of a regression function having one or more parameters. If the extrapolation is not reliable, the initial quantization parameter is determined from one or more quantization parameters of one or more previous ideal data representation frames.

In accordance with a second aspect of the present invention, a computer program product for provision of rate control for a video encoder is provided, which program product comprises a program/code section for performing an encoding process for each frame. A program/code section is arranged for determining an initial quantization parameter, which is to be used as a quantization parameter for encoding a current frame. A program/code section is adapted for encoding a group of macroblocks within the current frame group by group; i.e. group-wise. Therefore, the program/code section for macroblock encoding includes a program/code section provided in order to determine a score value after macroblock encoding of a current group of macroblocks. In case the score value exceeds a pre-defined threshold, a program/code section is comprised in order to allow for adjusting the quantization parameter for encoding the next group of macroblocks. Otherwise, a program/code section is provided for continuing macroblock encoding with the quantization parameter, which is currently used for encoding the current group of macroblocks.

According to an embodiment of the present invention, the score value is determined on the basis of at least one out of the group comprising one or more bit envelope values for the current frame, a predictive number of bits, which predicts a number of bits required for encoding the current macroblock at the time of encoding, and a macroblock index.

According to an embodiment of the present invention, the predictive number of bits is determined on the basis of the number of bits generated for encoding one or more previous macroblocks of the current frame and/or one or more one or more previous macroblocks of one or more previous frames.

According to an embodiment of the present invention, a program/code section is provided for determining the bit envelope values for the current frame. The bit envelope values include at least an upper limit and a lower limit. The envelope values are determined in accordance with a buffer model and/or are based on at least one value out of the group comprising a video bit rate, a target number of bits for the current frame and a video frame rate. A program section is provided for determining the score value on the basis of the predictive number of bits, the envelope values, and a pre-defined function to account for unreliability of the bit prediction. The pre-defined function is a function of the macroblock index and preferably a parabolic function implementable on the basis of a look-up table.

According to an embodiment of the present invention, the program/code section for adjusting of the quantization parameter comprises a program/code section for offsetting the quantization parameter by at least one offset value. The at least one offset value is preferably dependent on the envelope values and/or the determined predictive number of bits.

According to an embodiment of the present invention, the program/code section for adjusting of the quantization parameter is arranged to determine the quantization parameter in dependence on the score value.

According to an embodiment of the present invention, a program/code section is provided for initializing at least one rate control-related parameter. The at least one rate control-related parameter is preferably selected from the group consisting of bit rate and buffer size.

According to an embodiment of the present invention, a program/code section is provided for determining a number of macroblocks, which have been encoded since the last quantization parameter adjustment has taken place. In case the number of macroblock exceeds a pre-defined threshold, the adjusting the quantization parameter is enabled.

According to an embodiment of the present invention, if necessary, a program/code section is comprised for determining an updated initial quantization parameter for the current frame and initiating the repetition of the frame encoding process of the current frame.

According to an embodiment of the present invention, a program/code section is further provided for determining whether the current frame is a P frame or an ideal data representation frame.

According to an embodiment of the present invention, if the current frame is a P-frame, the predictive number of bits is determined from a bit distribution of one or more previous frames.

According to an embodiment of the present invention, if the current frame is an ideal data representation frame, the predictive number of bits is determined from the number of bits generated at a previous frame.

According to an embodiment of the present invention, if the current frame is a P frame, the initial quantization parameter is determined by the means of a program/code section for calculating values for short window and long window quantization parameters; a program/code section for calculating the initial quantization parameter based upon the short window and long window quantization parameters; a program/code section for clipping the value for the frame's initial quantization parameter.

According to an embodiment of the present invention, if the current frame is an ideal data representation frame, the program section for initial quantization parameter comprises one or more of the following program/code sections. A program section is provided for employing a quantization parameter of the previous P-frame as the initial quantization parameter, if a buffer availability check in accordance with the buffer model is successful. A further program/code section is provided for extrapolating the initial quantization parameter from the number of bits generated for one or more previous frames and the quantization parameters used for encoding the one or more previous frames and clipping the extrapolated quantization parameter, if the buffer availability check fails, The extrapolation is preferably based on a regression calculation on the basis of a regression function having one or more parameters. A program/code section is finally provided for determining the initial quantization parameter from one or more quantization parameters of one or more previous ideal data representation frames, if the extrapolation is not reliable.

In accordance with a third aspect of the present invention, an electronic device including at least a processor or processing unit and a memory unit is provided. The memory unit is operatively connected to the processor and includes a computer program product for rate control of a video encoder. A program/code section is arranged for determining an initial quantization parameter, which is to be used as a quantization parameter for encoding a current frame. A program/code section is adapted for encoding a group of macroblocks within the current frame group by group; i.e. group-wise. Therefore, the program/code section for macroblock encoding includes a program/code section provided in order to determine a score value after macroblock encoding of a current group of macroblocks. In case the score value exceeds a pre-defined threshold, a program/code section is comprised in order to allow for adjusting the quantization parameter for encoding the next group of macroblocks. Otherwise, a program/code section is provided for continuing macroblock encoding with the quantization parameter, which is currently used for encoding the current group of macroblocks.

According to an embodiment of the present invention, the score value is determined on the basis of at least one out of the group comprising one or more bit envelope values for the current frame, a predictive number of bits, which predicts a number of bits required for encoding the current macroblock at the time of encoding, and a macroblock index.

According to an embodiment of the present invention, the predictive number of bits is determined on the basis of the number of bits generated for encoding one or more previous macroblocks of the current frame and/or one or more one or more previous macroblocks of one or more previous frames.

According to an embodiment of the present invention, a program/code section is provided for determining the bit envelope values for the current frame. The bit envelope values include at least an upper limit and a lower limit. The envelope values are determined in accordance with a buffer model and/or are based on at least one value out of the group comprising a video bit rate, a target number of bits for the current frame and a video frame rate. A program section is provided for determining the score value on the basis of the predictive number of bits, the envelope values, and a pre-defined function to account for unreliability of the bit prediction. The pre-defined function is a function of the macroblock index and preferably a parabolic function implementable on the basis of a look-up table.

According to an embodiment of the present invention, the program/code section for adjusting of the quantization parameter comprises a program/code section for offsetting the quantization parameter by at least one offset value. The at least one offset value is preferably depending on the envelope values and/or the determined predictive number of bits.

According to an embodiment of the present invention, the program/code section for adjusting of the quantization parameter is arranged to determine the quantization parameter in dependence of the score value.

According to an embodiment of the present invention, a program/code section is provided for initializing at least one rate control-related parameter. The at least one rate control-related parameter is preferably selected from the group consisting of bit rate and buffer size.

According to an embodiment of the present invention, a program/code section is provided for determining a number of macroblocks, which have been encoded since the last quantization parameter adjustment has taken place. In case the number of macroblocks exceeds a pre-defined threshold, the adjusting the quantization parameter is enabled.

According to an embodiment of the present invention, if necessary, a program/code section is comprised for determining an updated initial quantization parameter for the current frame and initiating the repetition of the frame encoding process of the current frame.

According to an embodiment of the present invention, a program/code section is further provided for determining whether the current frame is a P frame or an ideal data representation frame.

According to an embodiment of the present invention, if the current frame is a P-frame, the predictive number of bits is determined from a bit distribution of one or more previous frames.

According to an embodiment of the present invention, if the current frame is an ideal data representation frame, the predictive number of bits is determined from the number of bits generated at a previous frame.

According to an embodiment of the present invention, if the current frame is a P frame, the initial quantization parameter is determined by the means of a program/code section for calculating values for short window and long window quantization parameters; a program/code section for calculating the initial quantization parameter based upon the short window and long window quantization parameters; a program/code section for clipping the value for the frame's initial quantization parameter.

According to an embodiment of the present invention, if the current frame is an ideal data representation frame, the program section for initial quantization parameter comprises one or more of the following program/code sections. A program section is provided for employing a quantization parameter of the previous P-frame as the initial quantization parameter, if a buffer availability check in accordance with the buffer model is successful. A further program/code section is provided for extrapolating the initial quantization parameter from the number of bits generated for one or more previous frames and the quantization parameters used for encoding the one or more previous frames and clipping the extrapolated quantization parameter, if the buffer availability check fails, The extrapolation is preferably based on a regression calculation on the basis of a regression function having one or more parameters. A program/code section is finally provided for determining the initial quantization parameter from one or more quantization parameters of one or more previous ideal data representation frames, if the extrapolation is not reliable.

In accordance with a fourth aspect of the present invention, a video encoder operable with rate control module is provided. The video encoder is arranged to perform frame encoding for each frame, i.e. frame-wise. An initial frame QP calculator comprised by the video encoder is arranged for determining an initial quantization parameter for being used as a quantization parameter for encoding a current frame. The said video encoder is further arranged for macroblock encoding of each group of macroblocks within a current frame, i.e. group-wise. A QP adjuster comprised by the video encoder is arranged for determining a score value after encoding of a current group of macroblocks of the current frame to be encoded. The QP adjuster is adapted to adjust the quantization parameter for encoding a next group of macroblocks in case the score value exceeds a pre-defined threshold. Otherwise QP adjuster is adapted to maintain the quantization parameter, which is employed for the current macroblock encoding, for subsequent macroblock encoding of the next group of macroblocks.

According to an embodiment of the present invention, the QP adjuster is arranged for determining said score value on the basis of at least one out of the group comprising one or more bit envelope values for the current frame, a predictive number of bits, which predicts a number of bits required for encoding the current macroblock at the time of encoding, and a macroblock index.

According to an embodiment of the present invention, a bit predictor comprised by the video encoder is arranged for determining the predictive number of bits on the basis of number of bits generated for encoding one or more previous macroblocks of the current frame and/or one or more one or more previous macroblocks of one or more previous frames.

According to an embodiment of the present invention, a bit envelope calculator comprised by the video encoder is arranged for determining the bit envelope values for the current frame. The bit envelope values include at least an upper limit and a lower limit. The bit envelope values are determined in accordance with a buffer model and/or the bit envelope values are based on at least one value out of the group comprising a video bit rate, a target number of bits for the current frame and a video frame rate. The QP adjuster is arranged for determining the score value on the basis of the predictive number of bits, the envelope values, and a pre-defined function to account for unreliability of the bit prediction. The pre-defined function is preferably a function of the macroblock index and is more preferably a parabolic function implementable on the basis of a look-up table.

According to an embodiment of the present invention, the QP adjuster is arranged for adjusting the quantization parameter in that the quantization parameter is offset by at least one offset value. The at least one offset value is preferably dependent on the envelope values and/or the determined predictive number of bits.

According to an embodiment of the present invention, the QP adjuster is arranged for adjusting the quantization parameter in dependence on the score value.

According to an embodiment of the present invention, at least one rate control-related parameter is provided, which is preferably selected from the group consisting of bit rate and buffer size.

According to an embodiment of the present invention, the QP adjuster is arranged for determining a number of macroblocks, which have been encoded since the last quantization parameter adjustment has taken place. In case the number of macroblock exceeds a pre-defined threshold, the quantization parameter adjustment is enabled.

According to an embodiment of the present invention, the initial frame QP calculator is arranged for determining an updated initial quantization parameter for the current frame and initiating repetition of the frame encoding process of the current frame, if necessary.

According to an embodiment of the present invention, it is determined whether the current frame is a P frame or an ideal data representation frame.

According to an embodiment of the present invention, if the current frame is a P-frame, the bit predictor is arranged for determining the predictive number of bits from a bit distribution of one or more previous frames.

According to an embodiment of the present invention, if the current frame is an ideal data representation frame, the bit predictor is arranged for determining the predictive number of bits from the number of bits generated at a previous frame.

According to an embodiment of the present invention, if the current frame is a P frame, the initial frame QP calculator is arranged for calculating values for short window and long window quantization parameters; calculating the initial quantization parameter based upon the short window and long window quantization parameters; and/or clipping the value for the frame's initial quantization parameter.

According to an embodiment of the present invention, if the current frame is an ideal data representation frame, the initial frame QP calculator is arranged for operation in accordance with the following decisions. If a buffer availability check in accordance with the buffer model is successful, the initial frame QP calculator is arranged for employing a quantization parameter of the previous P-frame as the initial quantization parameter. If the buffer availability check fails, the initial frame QP calculator is arranged for extrapolating the initial quantization parameter from the number of bits generated for one or more previous frames and the quantization parameters used for encoding the one or more previous frames and clipping the extrapolated quantization parameter. The extrapolation is preferably based on a regression calculation on the basis of a regression function having one or more parameters. If the extrapolation is not reliable, the initial frame QP calculator is arranged for determining the initial quantization parameter from one or more quantization parameters of one or more previous ideal data representation frames.

In general, the present invention relates to a rate control scheme which is advantageously arranged to be operated at low-delay applications, such as conversational. Hence, the rate control scheme according to an embodiment of the present invention is able to achieve tight buffer regulation, which means that when encoding the frames approximately the same number of bits is generated, even though the frames may have varying encoding complexities. Thus, quality variation resulting from the proposed rate controller may be higher than those resulting from VBR (variable bit rate) family rate controllers that operate on higher buffer levels. But, the complexity of an algorithm according to an embodiment of the present invention is kept at low levels to enable its implementation on devices with memory and/or processing capability constraints. For example, utilizing a macroblock-level rate distortion model would improve the performance at the expense of increased complexity. Also, an algorithm according to an embodiment of the present invention does not perform any look-ahead either at macroblock level or at frame level. So, some constant bit rate (CBR) algorithms with significantly increased complexity may have increased performance. Nevertheless, the present invention provides a rate control scheme, which represents a solution considering the balance between quality of encoding and reproducing and demands made on computing complexity.

### BRIEF DESCRIPTION OF THE SEVERAL VIEWS OF THE DRAWING

These and other objects, advantages and features of the invention, together with the organization and manner of operation thereof, will become apparent from the following detailed description when taken in conjunction with the accompanying drawings, wherein like elements have like numerals throughout the several drawings described below. Preferred embodiments of the present invention will now be explained with reference to the accompanying drawings of which:

FIG. 1a shows a block diagram illustrating schematically a general processing system according to an embodiment of the present invention;

FIG. 1b shows a block diagram illustrating schematically a further processing system according to an embodiment of the present invention;

FIG. 2 shows a block diagram illustrating schematically components of a video encoder according to an embodiment of the present invention;

FIG. 3 shows a flow diagram illustrating an operational sequence for operating a rate controller of a video encoder according to an embodiment of the present invention; and

FIG. 4 shows a block diagram illustrating schematically components of a rate controller of a video encoder according to an embodiment of the present invention.

### DETAILED DESCRIPTION OF THE INVENTION

Features and advantages according to the aspects of the invention will become apparent from the following detailed description, taken together with the drawings. It should be noted that same and like components throughout the drawings are indicated with the same reference number.

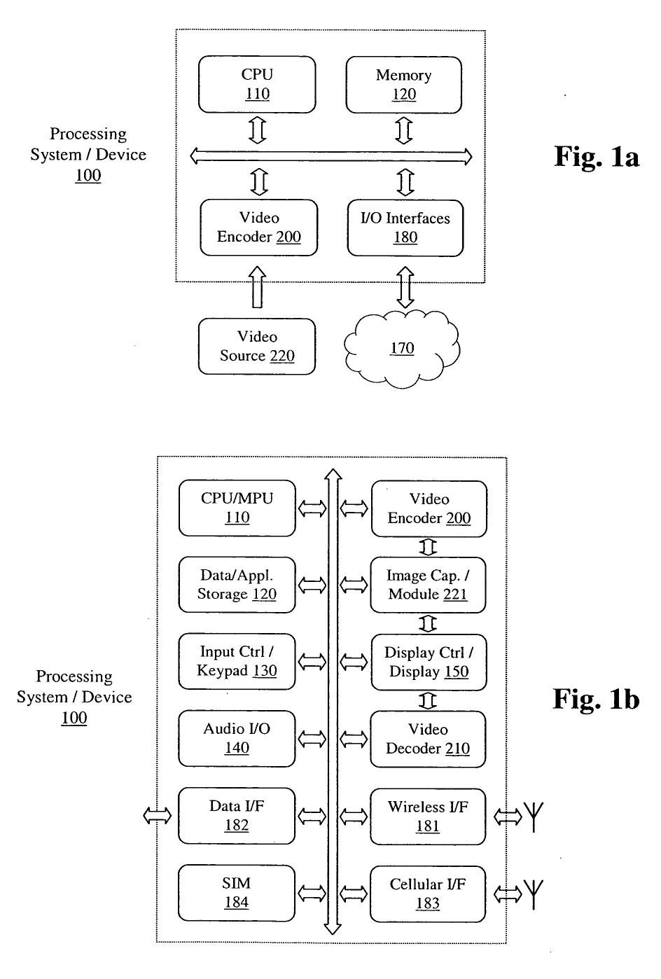

With reference to FIGS. 1a and 1b, structural components of processing systems 100 according to embodiments of the present invention are schematically illustrated.

The block diagram of FIG. 1a illustrates principle structural components of a processing system 100, which should exemplarily represent any kind of processing system or processing device employable with the present invention. The processing system 100 may represent any general purpose computer system. It should be understood that the present invention is not limited to any specific processing system.

The illustrated processing system 100 in a generalized embodiment is based on a processing unit (CPU) 110 being connected to a memory 120. The memory 120, which comprises any random access memory (RAM) and/or read-only memory (ROM), is provided for string data and/or one or more applications, which are operable with the processing system 100. The one or more applications include especially any user application software for being carried out on the processing system as well as one or more operating systems and device driver software required for operating the processing system and its further hardware components (only partly illustrated).

The processing system can be coupled to a plurality of input/output devices (not shown) including for instance a keyboard, a keypad, a mouse, a display and, any storage devices including but not limited to hard disk drives, tape drives, floppy disk, compact disc drives, and digital versatile disk drives.

One or more general input/output (I/O) interfaces 180 may be comprised by the processing system, which enables for data communication via any data communication network 170, preferably any packet-switched data communication network. It should be noted that the one or more input/output (I/O) interfaces 180 should not be understood as being limited to network interfaces but the input/output (I/O) interfaces 180 may also comprise any interface applicable for data exchange.

Further, the processing system 100 comprises a video encoder 200, which is coupled to a general video source 220 for receiving a video input signal. The video source 200 may include but not limited a video camera, a camcorder, a video recorder, any video signal receiver capable of receiving radio frequency television broadcast signals such as digital TV broadcast signals (including e.g. DVB-T/S/C (digital video broadcasting—terrestrial/satellite/cable) signals and/or analog TV broadcast signals (including e.g. PAL (Phase Alternation Line) coded TV RF signals, NTSC (National Television System Committee) coded TV RF signals, and/or SECAM (Systéme Electronique Couleur Avec Mémoire) coded TV RF signals), any imaging device including a digital camera, scanner and the like, and an analog and/or digital video recorder.

The video input source 220 serves to provide video input signals to the video encoder 220 comprised by the processing system 100 for producing encoded (digital) video bitstreams. Likewise, sequences of video pictures may be received from any storage device or any imaging device for being supplied to the video encoder 220 producing one or more encoded (digital) video bitstreams thereof. The resulting video bitstreams are preferably communicated via any input/output interface 180 to a device or system capable of reproducing the video sequences from the encoded video bitstream.

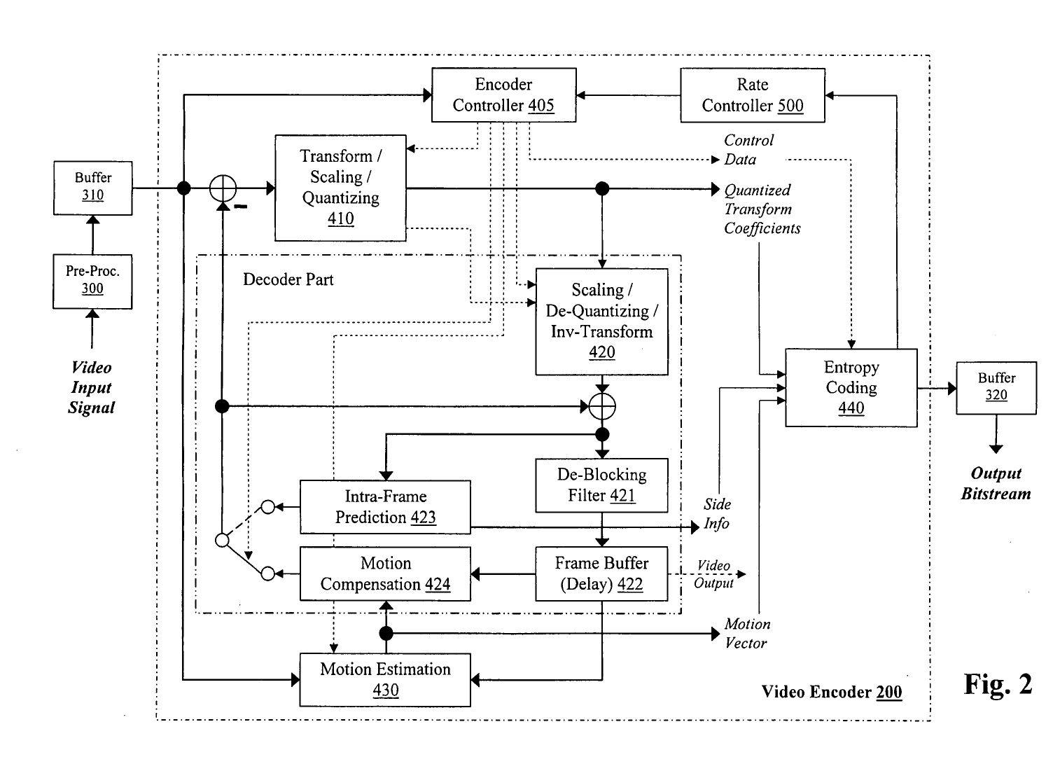

A more specific embodiment of the processing system 100 will be illustrated with reference to FIG. 1b and an embodiment of the video encoder 200 will be described in detail with reference to FIG. 2. In particular, the embodiment shown in FIG. 1b comprises also embodiments of the input/output interfaces illustrated in general above.

The block diagram of FIG. 1b illustrates principle structural components of a portable processing system 100, which should exemplarily represent any kind of processing system or device employable with the present invention. It should be understood that the present invention is neither limited to the illustrated portable processing system 100 nor to any other specific kind of processing system or device.

The illustrated processing system 100 is exemplarily carried out as cellular communication enabled portable user terminal. In particular, the processing system 100 is embodied as a processor-based or micro-controller based system comprising a central processing unit (CPU) and a mobile processing unit (MPU) 110, respectively, a data and application storage 120, cellular communication means including cellular radio frequency interface (I/F) 183 with radio frequency antenna (outlined) and subscriber identification module (SIM) 184, user interface input/output means including typically audio input/output (I/O) means 140 (typically microphone and loudspeaker), keys, keypad and/or keyboard with key input controller (Ctrl) 130 and a display with display controller (Ctrl) 150, a (local) wireless data interface (I/F) 181, and a general data interface (I/F) 182. Further, the processing system 100 comprises a video encoder module 200, which is capable of encoding/compressing video input signals to obtain compressed digital video sequences (and e.g. also digital pictures) in accordance with one or more video codecs and especially operable with an image capturing module 220 providing video input signals, and a video decoder module 210 enabled for encoding compressed digital video sequences (and e.g. also digital pictures) in accordance with one or more video codecs.

The operation of the processing system 100 is controlled by the central processing unit (CPU)/mobile processing unit (MPU) 110 typically on the basis of an operating system or basic controlling application, which controls the functions, features and functionality of the processing system 100 by offering their usage to the user thereof. The display and display controller (Ctrl) 150 are typically controlled by the processing unit (CPU/MPU) 110 and provides information for the user including especially a (graphical) user interface (UI) allowing the user to make use of the functions, features and functionality of the processing system 100. The keypad and keypad controller (Ctrl) 130 are provided to enable the user to input information. The information input via the keypad is conventionally supplied by the keypad controller (Ctrl) to the processing unit (CPU/MPU) 110, which may be instructed and/or controlled in accordance with the input information. The audio input/output (I/O) means 140 includes at least a speaker for reproducing an audio signal and a microphone for recording an audio signal. The processing unit (CPU/MPU) 110 can control conversion of audio data to audio output signals and the conversion of audio input signals into audio data, where for instance the audio data have a suitable format for transmission and storing. The audio signal conversion of digital audio to audio signals and vice versa is conventionally supported by digital-to-analog and analog-to-digital circuitry e.g. implemented on the basis of a digital signal processor (DSP, not shown).

The processing system 100 according to a specific embodiment illustrated in FIG. 1b includes the cellular interface (I/F) 183 coupled to the radio frequency antenna (not shown) and is operable with the subscriber identification module (SIM) 184. The cellular interface (I/F) 183 is arranged as a cellular transceiver to receive signals from the cellular antenna, decodes the signals, demodulates them and also reduces them to the base band frequency. The cellular interface (I/F) 183 provides for an over-the-air interface, which serves in conjunction with the subscriber identification module (SIM) 184 for cellular communications with a corresponding base station (BS) of a radio access network (RAN) of a public land mobile network (PLMN).

The output of the cellular interface (I/F) 183 thus consists of a stream of data that may require further processing by the processing unit (CPU/MPU) 110. The cellular interface (I/F) 183 arranged as a cellular transceiver is also adapted to receive data from the processing unit (CPU/MPU) 110, which is to be transmitted via the over-the-air interface to the base station (BS) of the radio access network (RAN). Therefore, the cellular interface (I/F) 183 encodes, modulates and up converts the data embodying signals to the radio frequency, which is to be used for over-the-air transmissions. The antenna (not shown) of the processing system 100 then transmits the resulting radio frequency signals to the corresponding base station (BS) of the radio access network (RAN) of the public land mobile network (PLMN). The cellular interface (I/F) 183 preferably supports a 2nd generation digital cellular network such as GSM (Global System for Mobile Communications) which may be enabled for GPRS (General Packet Radio Service) and/or EDGE (Enhanced Data for GSM Evolution), UMTS (Universal Mobile Telecommunications System), and/or any similar or related standard for cellular telephony standard.

The wireless data interface (I/F) 181 is depicted exemplarily and should be understood as representing one or more wireless network interfaces, which may be provided in addition to or as an alternative of the above described cellular interface (I/F) 183 implemented in the exemplary processing system 100. A large number of wireless network communication standards are today available. For instance, the processing system 100 may include one or more wireless network interfaces operating in accordance with any IEEE 802.xx standard, Wi-Fi standard, any Bluetooth standard (1.0, 1.1, 1.2, 2.0 ER), ZigBee (for wireless personal area networks (WPANs)), infra-red Data Access (IRDA), any other currently available standards and/or any future wireless data communication standards such as UWB (Ultra-Wideband).

Moreover, the general data interface (I/F) 182 is depicted exemplarily and should be understood as representing one or more data interfaces including in particular network interfaces implemented in the exemplary processing system 100. Such a network interface may support wire-based networks such as Ethernet LAN (Local Area Network), PSTN (Public Switched Telephone Network), DSL (Digital Subscriber Line), and/or other current available and future standards. The general data interface (I/F) 182 may also represent any data interface including any proprietary serial/parallel interface, a universal serial bus (USB) interface, a Firewire interface (according to any IEEE 1394/1394a/1394b etc. standard), a memory bus interface including ATAPI (Advanced Technology Attachment Packet Interface) conform bus, a MMC (MultiMediaCard) interface, a SD (SecureData) card interface, Flash card interface and the like.

The components and modules illustrated in FIG. 1b may be integrated in the processing system 100 as separate, individual modules, or in any combination thereof. Preferably, one or more components and modules of the processing system 100 may be integrated with the processing unit (CPU/MPU) forming a system on a chip (SoC). Such system on a chip (SoC) integrates preferably all components of a computer system into a single chip. A SoC may contain digital, analog, mixed-signal, and also often radio-frequency functions. A typical application is in the area of embedded systems and portable systems, which are constricted especially to size and power consumption constraints. Such a typical SoC consists of a number of integrated circuits that perform different tasks. These may include one or more components comprising microprocessor (CPU/MPU), memory (RAM: random access memory, ROM: read-only memory), one or more UARTs (universal asynchronous receiver-transmitter), one or more serial/parallel/network ports, DMA (direct memory access) controller chips, GPU (graphic processing unit), DSP (digital signal processor) etc. The recent improvements in semiconductor technology have allowed VLSI (Very-Large-Scale Integration) integrated circuits to grow in complexity, making it possible to integrate all components of a system in a single chip.

The video encoder is adapted to receive a video input signal and encode a digital video sequence thereof, which can be stored, transmitted via any data communications interface, and/or reproduced by the means of the video decoder 210. The video encoder 200 is operable with any video codec. The video input signal may be provided by the image capturing module 221 of the processing system 100. The image capturing module 221 may be implemented or detachably connected to the processing system 100. An illustrative implementation of the video encoder 200 will be described below with reference to FIG. 2.

The image capturing module 221 is preferably a sensor for recording images. Typically such an image capturing module 221 consists of an integrated circuit (IC) containing an array of linked, or coupled, capacitors. Under the control of an external circuit, each capacitor can transfer its electric charge to one or other of its neighbors. Such integrated circuit containing an array of linked, or coupled, capacitors is well known by those skilled in the art as charge-coupled device (CCD). Other image capturing technologies may be also used.

The video decoder 210 is adapted to receive a digitally encoded/compressed video bitstream/sequence, preferably divided into a plurality of video data packets received via the cellular interface 183, the wireless interface (I/F) 181, any other data interface of the processing system 100 over a packet-based data communication network or from a data storage connected to the processing system 100. The video decoder 210 is operable with any video codecs. The video data packets are decoded by the video decoder and preferably outputted to be displayed via the display controller and display 150 to a user of the processing system 100. Details about the function and implementation of the video decoder 210 are out of the scope of the present invention.

Typical alternative portable processing systems or devices may include personal digital assistants (PDAs), hand-held computers, notebooks, so-called smart phones (cellular phone with improved computational and storage capacity allowing for carrying out one or more sophisticated and complex applications), which devices are equipped with one or more network interfaces enabling typically data communications over packet-switched data networks. The implementation of such typical micro-processor based devices capable for processing multimedia contents including encoding multimedia contents is well known in the art.

Those skilled in the art will appreciate that the present invention is not limited to any specific portable processing-enabled device, which represents merely one possible processing-enabled device, which is capable of carrying out the inventive concept of the present invention. It should be understood that the inventive concept relates to an advantageous implementation of a video encoder 200, which can be implemented on any processing-enabled device including a portable device as described above, a personal computer (PC), a consumer electronic (CE) device, a server and the like.

FIG. 2 illustrates schematically a basic block diagram of a video encoder according to an embodiment of the present invention. The illustrative video encoder shown in FIG. 2 depicts a hybrid decoder employing temporal and spatial prediction for video encoding such as being used for video encoding in accordance with the H.264 standard. It should be noted that the present invention is not limited to any specific video encoding standard or codec. Those skilled in the art will appreciate that the concept according to an embodiment of the present invention is applicable with any other video encoding standard including but not limited any MPEG x and any H.26x standard. The designation MPEG x should be understood as comprising in particular MPEG 1, MPEG 2, MPEG 4, and any specific profiles and levels thereof as well as any future developments. The designation H.26x should be understood as comprising in particular H.261, H.262, and H.263, H.264 as well as any future developments.

The first frame or a random access point of a video sequence is generally coded without use of any information other than that contained in the first frame. This type of coding is designated “Intra” coding, i.e. the first frame is typically “Intra” coded. The remaining pictures of the videos sequence or the pictures between random access points of the video sequence are typically coded using “Inter” coding. “Inter” coding employs prediction (especially motion compensation prediction) from other previously decoded pictures. The encoding process for “Inter” prediction or motion estimation is based on choosing motion data, comprising the reference picture, and a spatial displacement that is applied to all samples of the block. The motion data which is transmitted as side information is used by the encoder and decoder to simultaneously provide the “Inter” prediction signal. The video encoder 200 preferably creates a series of (e.g. periodic) reference image frames (i.e. “Intra” or I-frames) intermingled with intervening predicted image frames (i.e. “Inter” frames including P-frames and/or B-frames) to maximize image coding efficiency while maintaining high image quality when reproduced by a video decoder such as the video decoder 210.

Referring to “Inter” encoding mode, taking a current frame receiver from the buffer 310, the video encoder chooses the best block in a reference frame provided either by an Intra-frame prediction unit 423 or a motion compensation unit 424 to calculate a difference frame, which is processed with transform, scaling, and quantization operations performed by means of a transformer, scaler, and quantizer. These units are schematically illustrated in a non-limiting way as an integrated transform, scaling, and quantizing unit 410. Then, the resulting quantized transform coefficients are entropy coded by means of an entropy coding unit 440 such that a compressed video bitstream results, which may be stored temporarily in a buffer 320 for being finally outputted. In other words, a residual of the prediction (either “Inter” or “Intra”), which is the difference between the original and the predicted block, is transformed, scaled, quantized and entropy coded. The now fully encoded video bit stream may be transferred to memory and then recorded on the desired media or transmitted to one or more desired receivers.

The entropy coding process represents a compressing process, which assigns shorter code words to symbols with higher probabilities of occurrence and longer code words to symbols with lower probabilities of occurrence. Different entropy encoding mechanisms are applicable with video encoding. For instance with reference to the H.264 video encoding standard, Context Adaptive Variable Length Coding (CAVLC) is used and, for instance with reference to Main profile broadcast content, an even more efficient Context Adaptive Binary Arithmetic Coding (CABAC) is used. In principle entropy encoding techniques take advantage of the frequency of occurrence and magnitude of non-zero coefficients in neighboring blocks to choose the variable length coding (VLC) lookup table to be used for each block.

Predicted “Intra” frames are reconstructed by taking the result of the quantization operation (herein the quantized transform coefficients outputted by transform, scaling, and quantizing unit 410), and applying the reverse operations including de-quantization, (re-)scaling, and inverse transform. Herein but not limited thereto, these units are schematically illustrated as an integrated de-quantizing, re-scaling and inverse transform unit 420. The resulting reconstructed or reproduced frame is applied to an “Intra” frame prediction unit 423, a de-blocking filter 421, and/or further (specific) processing units (not shown).

The transform and inverse transform operation is generally based on bijective transform algorithms, including in particular an exact or separable integer transform operable with H.264 video encoding standard for 4×4 sample/pixel sub-blocks and Discrete Cosine Transform (DCT) operable with MPEG x video encoding standard for 16×16 sample/pixel sub-blocks. The Discrete Cosine Transform (DCT) requires rounding and implies rounding errors, which is especially considerable with respect to inverse Discrete Cosine Transform (DCT). The exact or separable integer transform enables exact inverse transform due to integer calculation.

The transform coefficients resulting from the transform algorithm applied are quantized using a scalar quantization algorithm with typically one of 52 different step sizes that are increased for instance at a predetermined rate with reference to the H.264 video encoding standard, rather than at a constant increment and fewer step sizes in other video encoding standards, especially MPEG x video encoding standard. Again with reference to the example H.264 video encoding standard, the quantized transform coefficients within a sub-block correspond to different frequencies of the luminance and chrominance spatial values within the sub-block and start with the coefficient in the upper left hand corner representing the average DC value of the luminance or chrominance for the sub-block. The remaining coefficients representing the non-zero, ascending frequency values of luminance and chrominance, are typically arranged in a zigzag pattern.

The “Intra” prediction is based on using spatial estimation within a given video image frame. Initially, the video image frame is divided into a number of smaller blocks called macroblocks. The typical 16×16 sample/pixel macroblocks are sampled for luminance (Y) and chrominance components (Cb, Cr).

For an I-frame (Intra picture reference frame), only spatial redundancies within a picture are encoded without reference to the temporal relationships to other frames. This means that encoded I-frames are typically large in size and are applicable to serve as a reference for encoding other (P and B “Inter” predictive) frames. The intra-prediction coding of the luminance and chrominance uses the value of adjacent blocks (typically the blocks to the top and to the left) to predict the macroblock of interest. Then the difference between the predicted block and the actual block is encoded, resulting in fewer bits to represent each encoded macroblock. For instance, the H.264 video encoding standard supports nine modes of predicting 4×4 pixel luminance blocks, one DC prediction mode, and eight directional modes.

Inter-prediction is based on using motion estimation and motion compensation to take advantage of the temporal redundancies between successive frames in video sequences. Motion estimation operable with the motion estimation unit 430 results in motion vectors having a predetermined accuracy such as quarter pixel accuracy or half-pixel accuracy and based on the motion vectors, the motion compensation operable with the motion compensation unit 424 can provide motion compensation for block sizes of macroblocks including for instance 16×16, 16×8, 8×8, 8×4, 4×8, and 4×4 samples/pixels.

Depending on the video encoding standard used, Inter picture encoding can be based on one or more reference A (“Inter”) P-frame is referenced to previously encoded frames, in particular an (“Intra”) I-frame at the beginning of a sequence. A (“Inter”) B-frame is referenced to previously encoded frames and future frames.

A de-blocking filter 421 within the motion compensation loop is operable to reduce the vertical and horizontal artifacts along the block and sub-block edges to generate a reproduction of the original image improved in quality.

The video input signal to be encoded by the video encoder 200 outputting a resulting video output bitstream may be pre-processed by means of a pre-processing unit 300 before being supplied to the video encoder. Typically, the video input signal is frame-wise or picture-wise provided to the video encoder input, where a picture of a video sequence can be a frame or a field. As aforementioned, each picture is split into macroblocks each having a predefined fixed size. Each macroblock covers a rectangular area of the picture. Preferably, typical macroblocks have an area of 16×16 samples/pixels of the luminance component and 8×8 samples/pixels of each of the two chrominance components.

Typical video coding techniques typically use the YCbCr color space for presentation, where Y is the luminance component, Cb is the blue color difference component or first chrominance component, and Cr is the red color difference component or second chrominance component. Research into the Human Visual System (HVS) has shown that the human eye is most sensitive to changes in luminance, and less sensitive to variations in chrominance. Hence, the use of YCbCr color space represents a favorable way for considering chrematistics of the human eye. If required, the pre-processing unit 300 allows transforming the video input signal from RGB (red, green, blue component) color space into YCbCr color space.

In general, rate control mechanisms for video encoders such as the video encoder 200 allows dynamic adjustment of encoder parameters to achieve a target bit rate of the resulting bitstream. Rate control mechanisms allocate a budget of bits to each group of pictures, individual frame, and/or sub-frame in a video sequence. Block-based hybrid video encoding schemes such as those applicable with MPEG x and H.26x video encoding standards are inherently lossy video encoding mechanisms. The compression is not only achieved by removing truly redundant information from bitstreams, but also by making small quality compromises in ways that is intended to be minimally perceptible.

In particular, the quantization parameter QP is provided to adjust spatial details in the encoded frames. When quantization parameter QP is very small, almost all that detail is retained. As the quantization parameter QP is increased, some of that detail is aggregated so that the bit rate drops, but at the price of some increase in distortion and some loss of quality in reproduction. This means, with increasing bit rate of the output bitstream of a video encoder such as video encoder 200 the quality of reproduction of the video bitstream increases and the distortions perceptible by an observer of the reproduction decreases.

A simple approach may provide two key inputs, i.e. the uncompressed video input signal and a (predefined) value for quantization parameter QP. As the processing of the source video input signal progresses, a compressed video of fairly constant quality in reproduction is obtainable, but the bit rate may vary dramatically. Because the complexity of frames is continually changing in a real video input signal, it is not obvious what value of quantization parameter QP should be specified.

In practice, constraints may be imposed by the decoder buffer size and by the network bandwidth which will force video to be encoded at a more nearly constant target bit rate. This means, the quantization parameter QP has to be dynamically varied on the basis of a determination or estimation of the complexity of the source signal, which is typically a video input signal. This means that each frame or group of pictures (GOP) gets an appropriate allocation of bits. Rather than specifying quantization parameter QP as input, a demanded bit rate should be specified instead. In other words, a closed loop rate control is advantageous. It should be noted that the group of picture (GOP) concept is inherited from typical video encoding standards including the MPEG and H.26x standards and refers to an I-picture/frame, followed by all the P and B-pictures/frames until the next I-picture/frame. For instance, a typical MPEG GOP structure might be IBBPBBPBBI.

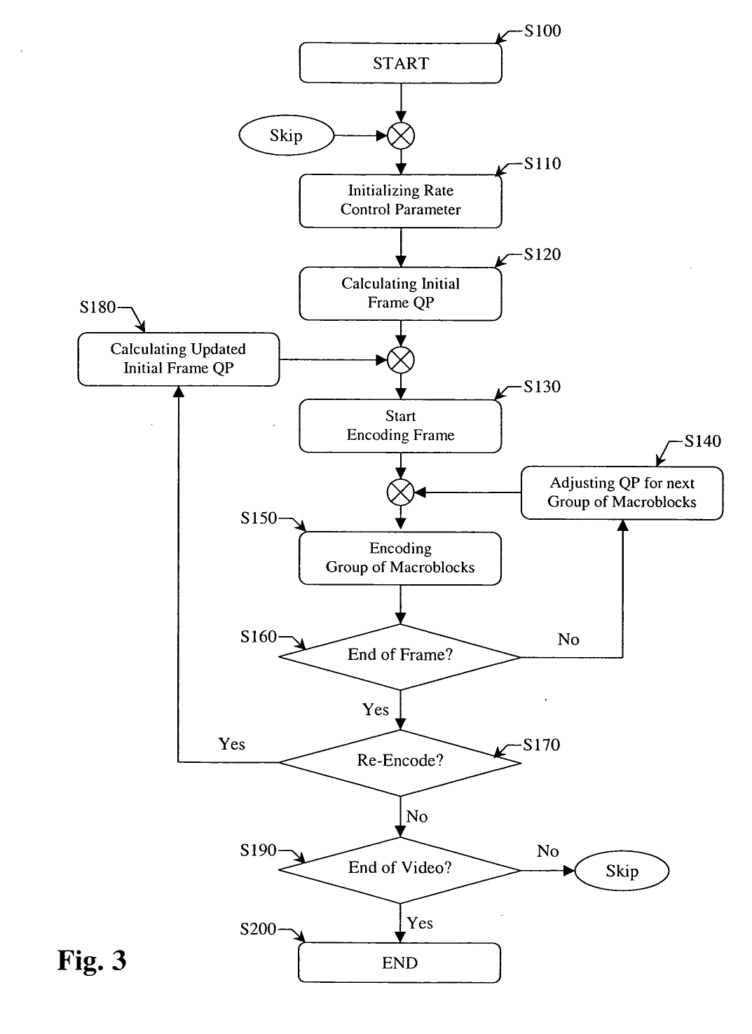

With reference to FIG. 3, a rate control mechanism according to an embodiment of the invention is illustrated. In more detail, FIG. 3 shows a flow diagram illustrating an operational sequence of the rate control mechanism according to an embodiment of the present invention.

The operational sequence can be portioned into the following principle operations:
Calculating initial frame quantization parameter QP;
Calculating a bit-envelope for the frame; and
Adjusting the quantization parameter QP after encoding a group-of-macroblocks.

First, the principle operations will be described with reference to an embodiment of the present invention.

Calculating Initial Frame Quantization Parameter QP

Because the rate distortion (RD) characteristics of (“Intra”) IDR-frames (ideal data representation frame) are significantly different than those of (“Inter”) P and B-frames, different methods are employed to calculate the initial QP for those types of frames. Those skilled in the art will understand that an IDR-frame refers to a coded frame containing only slices with I (or SI) slice types that causes a “reset” in the decoding process. After the decoding of an IDR-frame all following coded pictures in decoding order can be decoded without inter prediction from any picture decoded prior to the IDR-frame. The I-frame defined above is such an IDR-frame. Typically, the entropy encoder outputs slices, which are bit strings that contain macroblock data of an integer number of macroblocks, and the information of the slice header, which contains the spatial address of the first macroblock in the slice, the initial quantization parameter, and similar.

Calculating Initial Frame Quantization Parameter QP for Inter Frames

With reference to the initial frame quantization parameter QP Calculation for (“Inter”) P and B-frames, a target number of bits for the frame is calculated using the following equation:

$${R}_{target} ( i ) = \{ \begin{matrix}\frac{{R}_{video}}{f} - \frac{{Δ}_{error}}{W} , number of frames to code is not known \\ \frac{{R}_{video}}{f} - \frac{{Δ}_{error}}{MIN ( W , num\_frames - i )} , number of frames to code is known\end{matrix} , \qquad Eq . ( 1 )$$

where R_{target}(i) is the target number of bits for the i^{th} frame;
R_{video} is the video bit rate;
ƒ is the frame rate for the video sequence;
Δₑᵣᵣₒᵣ is the difference between the number of bits used till coding the i^{th} frame and the number of bits that would be used if all the prior frames were coded at an ideal rate of R_{video}/ƒ;
W is the bit adjust window length; and
num_frames is the total number of frames of the video.

After the target number of bits for the frame is calculated by the means of equation (1), two quantization parameters are obtainable, a short window quantization parameter QP_{SW} and long window quantization parameter QP_{LW}, from the following quadratics:

$$\begin{matrix}\frac{{R}_{target} ( i ) * \frac{{R}_{tex} ( i - 1 )}{{R}_{tex} ( i - 1 ) + {R}_{header} ( i - 1 )}}{{MAD}_{avg} ( SW\_size )} = \frac{{a}_{1 , SW}}{{QP}_{SW}^{2}} + \frac{{a}_{2 , SW}}{{QP}_{SW}} , and & Eq . ( 2 ) \\ \frac{{R}_{target} ( i ) - {R}_{header , avg} ( LW\_size )}{{MAD}_{avg} ( LW\_size )} = \frac{{a}_{1 , LW}}{{QP}_{LW}^{2}} + \frac{{a}_{2 , LW}}{{QP}_{LW}} , & Eq . ( 3 )\end{matrix}$$

where Rₜₑₓ(i-1) is a number of texture bits used for coding the previous frame;
R_{header}(i-1) is a number of header bits used for coding the previous frame;
SW_size is window size of a short window rate distortion model;
LW_size is a window size of a long window rate distortion model;
MAD_{avg}(x) is an average value of a mean average difference (MAD) of previous frame calculated over a window size; and
(a_{1,SW}, a_{2,SW}) and (a_{1,LW,} a_{2,LW}): are rate distortion model parameters for the short window and long window, respectively.

For exemplary implementation, the change in short window quantization parameter QP_{SW} and long window quantization parameter QP_{LW} may be limited to be equal to 2, and the QP_{LW} may be calculated once every 5 frames, where QP_{SW} is updated at every frame.

Next, a buffer fullness ratio γ is defined as,

$$γ = \frac{{B}_{fullness} ( i ) + \frac{{R}_{video}}{f} \cdot n}{{B}_{size}} ,$$

where B_{fullness}(i) is a buffer occupancy at the time of coding frame i;
B_{size} is the size of the buffer; and
n is the number of consecutive frame skips happened before encoding frame i.

Using the buffer fullness ratio γ and the two quantization parameters QP_{SW}, and QP_{LW}, the initial quantization parameter QP for the (“Inter”) P or B-frame can be calculated using the following piecewise-linear function:

$${QP}_{initial} ( i ) = \{ \begin{matrix}{QP}_{average} ( i - 1 ) - 2 , & γ < 0.05 \\ {QP}_{weighted} ( i ) , & 0.05 \leq γ < 0.35 \\ {QP}_{LW} , & 0.35 \leq γ < 0.65 . \\ {QP}_{weighted} ( i ) , & 0.65 \leq γ < 0.95 \\ {QP}_{average} ( i - 1 ) + 2 , & 0.95 \leq γ\end{matrix} \qquad Eq . ( 4 )$$

Equation 4 defines in particular three zones of operation in accordance with the buffer fullness ratio γ. These zones comprise a very critical zone where buffer fullness ratio γ<0.05 and 0.95<γ, a less critical zone for the buffer fullness ratio where 0.05<γ<0.35 and 0.65<γ<0.95, and an uncritical zone for the buffer fullness ratio where 0.35<γ<0.65.

For the uncritical zone for the fullness ratio (where 0.35<γ<0.65), the initial quantization parameter QP for the P or B-frame is the same as the quantization parameter QP_{LW} that favors a constant quality video when the buffer fullness is at the desired level.

For the very critical zones (where buffer fullness ratio γ<0.05 and 0.95<γ), the initial quantization parameter QP for the P or B-frame is disruptively changed from the average quantization parameter QP of the previous frame in accordance with the buffer fullness to avoid buffer overflow and underflows.

For the rest of the zones (especially for the buffer fullness ratio where 0.05<γ<0.35 and 0.65<γ<0.95), the quantization parameter QP is calculated using the following equation:

$${QP}_{weighted} ( i ) = \{ \begin{matrix}MAX ( \vert γ - 0.5 \vert \cdot 2 \cdot {QP}_{SW} + ( 1 - \vert γ - 0.5 \vert \cdot 2 ) \cdot {QP}_{LW} , {QP}_{LW} ) , & γ \leq 0.65 \\ MIN ( \vert γ - 0.5 \vert \cdot 2 \cdot {QP}_{SW} + ( 1 - \vert γ - 0.5 \vert \cdot 2 ) \cdot {QP}_{LW} , {QP}_{LW} ) , & γ \leq 0.35\end{matrix} . \qquad Eq . ( 5 )$$

The QP_{weighted} is the weighted average of the quantization parameters QP_{SW} and QP_{LW}. The corresponding weights of the quantization parameters QP_{SW} and QP_{LW} depend on the buffer fullness ratio γ. If the buffer is close to overflow or underflow, the quantization parameter QP_{SW} will have a larger weight favoring constant bit rate video, whereas the quantization parameter QP_{LW} will have a larger weight when the buffer fullness ratio γ is not critical favoring constant quality video.

For low delay applications, it is favorable for the rate controller to react to frame skipping due to buffer overflow, thus QP_{weighted}(i) is further adjusted according to the number of consecutive frame skips that happened before encoding the frame i.

Calculating Initial Frame Quantization Parameter QP for Intra Frames

If the IDR-frame is the first frame in the video sequence, the algorithm uses the initial quantization parameter QP provided for instance by a user or being pre-defined. If the initial quantization parameter QP is not provided, the algorithm estimates an initial quantization parameter QP at a given (pre-defined) bit rate using the same method as disclosed in Joint Video Team (JVT) of the ISO/IEC (International Organization for Standardization/International Electrotechnical Commission) MPEG & ITU-T (Telecommunication Standardization Sector of the International Telecommunication Union); Document JVT-H014 “Adaptive Rate Control with HRD Consideration”, which should be incorporated by reference herewith.

If the resulting number of bits causes buffer to overflow, first (“Intra”) IDR-frame may be re-encoded using a larger quantization parameter QP.

For subsequent IDR-frames, the buffer availability is checked. The number of bits Bₐᵥₐᵢₗ(i) available in the buffer for the i^{th} IDR-frame is given as:

$${B}_{avail} ( i ) = {B}_{size} - {B}_{fullness} ( i ) + \frac{{R}_{video}}{f} .$$

If number of bits Bₐᵥₐᵢₗ(i) is larger than a pre-defined threshold the quantization parameter QP is calculated using a quantization parameter QP of a previous (“Inter”) P or B-frame. Otherwise, the following model is assumed to compute the quantization parameter QP for the (“Intra”) IDR-frames:

$${N}_{bits , IDR} [ … ] = \frac{a}{{QP}_{IDR}} + b , \qquad Eq . ( 6 )$$

where N_{bits,IDR}, is the number of bits generated for the (“Intra”) IDR-frames; and
QP_{IDR} is the quantization parameter QP used for the (“Intra”) IDR picture.

The encoding results of the past L IDR-frames are kept in two arrays, i.e. a first array N_{bits,IDR}[ . . . ] comprising the last L number of bits generated for the (“Intra”) IDR-frames N_{bits,IDR}, and a second array QP_{IDR}[ . . . ] comprising the last L quantization parameter QP used for the (“Intra”) IDR picture QP_{IDR}. Using the previous encoding results the model parameters a, and b can be obtained from a linear regression. If a is found to be greater than zero, the last samples in the array N_{bits,IDR}[ . . . ] and array QP_{IDR}[ . . . ] are removed and the linear regression is performed again. Then, it is checked whether the model described above is reliable to calculate the quantization parameter QP. The model is reliable in case
L>2; and
N_{bits,IDR,min}<Bₐᵥₐᵢₗ<N_{bits,IDR,max},
where N_{bits,IDR,min} and N_{bits,IDR,max} are the minimum and maximum elements in the array N_{bits,IDR}[ . . . ], respectively.

In case that the model is reliable, QP_{IDR}(i) is calculated using Equation (6) and clipped with the following two equations:
QP_{IDR}(i)=MIN{QP_{IDR}(i), QP_{IDR}(i−1)+2}; and
QP_{IDR}(i)=MAX{QP_{IDR}(i), QP_{IDR}(i−1)−2},
where QP_{IDR}(i−1) is the quantization parameter QP of the last IDR-frame.

In case that the model is not reliable because L is smaller than 2, QP_{IDR}(i) is calculated in the following way:

$${QP}_{IDR} ( i ) = \{ \begin{matrix}{QP}_{IDR} - 1 , & {B}_{avail} > 1.2 \cdot {N}_{bits , IDR} ( i - 1 ) \\ {QP}_{IDR} + 1 , & {B}_{avail} < 0.8 \cdot {N}_{bits , IDR} ( i - 1 ) \\ {QP}_{IDR} , & otherwise\end{matrix} .$$

In case that the model is unreliable for the other reason, QP_{IDR}(i) is calculated as:

$${QP}_{IDR} ( i ) = \{ \begin{matrix}{QP}_{IDR , max} , & {B}_{avail} > {N}_{bits , IDR , max} \\ {QP}_{IDR , min} , & otherwise\end{matrix} ,$$

where QP_{IDR,min}=MIN{QP_{IDR}[ . . . ]}, and QP_{IDR,max}=MAX{QP_{IDR}[ . . . ]}.

Bit-Envelope Calculation

The bit-envelope consists of three variables including upper_limit, lower_limit, and centerBit. The variables upper_limit and lower_limit define the maximum and minimum number of bits allowed, respectively, and the variable centerBit defines the desired number of bits for the frame.

It has been found that having a high-quality (“Intra”) IDR-frame increases the overall quality of the video sequence. Hence, a large number of bits is preferably allocated for the (“Intra”) IDR-frames. The value of the variable upper_limit for IDR-frame i is found as:

$$upper\_limit ( i ) - {B}_{size} \cdot 0.95 - {B}_{fullness} ( i ) + \frac{{R}_{video}}{f} ,$$

where the variable upper_limit(i) is clipped from above by

$$\frac{{R}_{video}}{f} \cdot I\_P \_RATIO$$

and below with

$$\frac{{R}_{video}}{f}$$

and where I_P_RATIO is a pre-defined constant value. This means, that

$$upper\_limit ( i ) = MIN \{ upper\_limit ( i ) , \frac{{R}_{video}}{f} \cdot I\_P \_RATIO \} , and$$

$$upper\_limit ( i ) = MAX \{ upper\_limit ( i ) , \frac{{R}_{video}}{f} \} .$$

The value of the variable lower_limit for the (“Intra”) IDR-frame is found by subtracting

$$\frac{{R}_{video}}{f}$$

from the variable upper_limit; hence, the value of the variable lower_limit for IDR-frame i is found as:

$$lower\_limit ( i ) = upper\_limit ( i ) - \frac{{R}_{video}}{f} .$$

It should be noted that the variable centerBit is not used for (“Intra”) IDR-frames.

For (“Inter”) P or B-frames, following equations are used to calculate the bit-envelope:

$$\begin{matrix}If ( {B}_{current} ( i ) > {B}_{size} / 2 ) & \\ upper\_limit ( i ) = {R}_{target} ( i ) \cdot ( K - ( K - 1 ) \cdot ( \frac{{B}_{current} ( i )}{{B}_{size}} - 0.5 ) ) ; & \\ centerBit ( i ) = \frac{{R}_{target} ( i ) + upper\_limit ( i )}{2} ; and & Eq . ( 7.1 ) \\ lower\_limit ( i ) = \frac{centerBit ( i )}{J} ; & \\ else & \\ lower\_limit ( i ) = {R}_{target} ( i ) \cdot ( 1 - \frac{1}{J} ) \cdot 2 \cdot \frac{{B}_{current}}{{B}_{size}} ; & \\ centerBit ( i ) = \frac{lower\_limit ( i ) + {R}_{target} ( i )}{2} ; and & Eq . ( 7.2 ) \\ upper\_limit ( i ) = centerBit ( i ) \cdot K ; & \end{matrix}$$

where K and J are the pre-defined constant values and their values are preferably found empirically.

Finally, the variables upper_limit(i), lower_limit(i), and centerBit(i) are further clipped in accordance with the buffer fullness B_{fullness} to ensure that in case the number of bits generated for the frame falls within the bit-envelope, no buffer overflow or underflow occurs.

Macroblock (MB)-Level Quantization Parameter QP Control

For low delay applications, frame-level rate control does not provide sufficient control over the tight buffers hence MB-level control is necessary. There are two main parts introduced with the algorithm. First part is the so-called Bit-Predictor that predicts the number of bits that will be generated for the frame. Second part is the so-called QP-Adjuster that decides whether the quantization parameter QP should be changed and what would be the new value of the quantization parameter QP for the subsequent macroblocks (MBs).

Bit-Predictor

The aim of bit-predictor is to predict the number of bits that will be generated for the frame (frame i), before the encoding of the frame is completed. Assume, mb_{curr} refers to the macroblock number that is currently being encoded and mbₗₐₛₜ refers to the macroblock number, where the last adjustment of the quantization parameter QP took place, and mbₜₒₜₐₗ is the total number of macroblocks within a frame. If the previous frame has been a (“Inter”) P or B-frame, use could be made of the bit distribution of the previous frame for prediction. Assume that the notation N([mbₗₐₛₜ−mb_{addr}], i−1) indicates the number of bits generated in frame i−1 at the macroblock positions from mbₗₐₛₜ to mb_{addr}; i.e. the notation can be written as

$$N ( [ {mb}_{last} - {mb}_{addr} ] , i ) = {\sum }_{{mb}_{j} = {mb}_{last}}^{{mb}_{addr}} N ( {mb}_{j} , i ) .$$

The prediction for the current frame at the time of encoding macroblock number mb_{curr} is indicated as N_{pred}(i, mb_{curr}) and given as:

$${N}_{pred} ( i , {mb}_{curr} ) = N ( [ 0 - {mb}_{curr} ] , i ) + MIN ( 4 , MAX ( 0.25 , \frac{N ( [ {mb}_{last} - {mb}_{curr} ] , i )}{N ( [ 0 - {mb}_{curr} ] , i - 1 )} ) ) \cdot ( N ( [ 0 - {mb}_{total} ] , i - 1 ) - N ( [ 0 - {mb}_{curr} ] , i - 1 ) )$$

In case that the previous frame is an (“Intra”) IDR-frame or N([0−mb_{curr}] i−1) is equal to zero, than the bits generated at the previous frame is used as the prediction.

Quantization Parameter QP-Adjuster

The aim of the QP-Adjuster is to adjust the quantization parameter QP in macroblock level in order to keep the generated bits for the frame within its bit-envelope. In order not to update the quantization parameter QP a lot and cause many bits in the bitstream to signal the updated quantization parameter QP, the adjustment frequency is limited using an UpdateThreshold variable. The UpdateThreshold variable changes depending on the current macroblock number mb_{curr}. If the difference between the current macroblock number and the last macroblock number (mb_{curr}−mbₗₐₛₜ) is larger than the UpdateThreshold, then a score or score value based on several parameters is computed.

The score QP_{score} is calculated using the following equation:

$${QP}_{score} ( i ) = \{ \begin{matrix}{N}_{pred} ( i , {mb}_{curr} ) \cdot \frac{f ( {mb}_{curr} )}{upper\_limit ( i )} , & if {N}_{pred} ( i , {mb}_{curr} ) > upper\_limit ( i ) \\ f ( {mb}_{curr} ) \cdot \frac{lower\_limit ( i )}{{N}_{pred} ( i , {mb}_{curr} )} , & if {N}_{pred} ( i , {mb}_{curr} ) < lower\_limit ( i ) \\ δ \cdot f ( {mb}_{curr} ) \cdot \frac{center\_bit ( i )}{{N}_{pred} ( i , {mb}_{curr} )} , & if lower\_limit ( i ) < {N}_{pred} ( i , {mb}_{curr} ) < center\_bit ( i ) \\ δ \cdot f ( {mb}_{curr} ) \cdot \frac{{N}_{pred} ( i , {mb}_{curr} )}{center\_bit ( i )} , & if center\_bit ( i ) < {N}_{pred} ( i , {mb}_{curr} ) < upper\_limit ( i ) \\ 0 , & otherwise ,\end{matrix} \qquad Eq . ( 8 )$$

where δ is a (pre-defined) constant value, and ƒ(mb_{curr}) is a function to account for unreliability of bit prediction at the starting macroblocks.

This function ƒ(mb_{curr}) is implemented using a look-up table, and its values are given as:

$$f [ \frac{{mb}_{curr}}{{mb}_{total}} \cdot 20 ] = [ 0.66 , 0.66 , 0.66 , 0.66 , 0.66 , 0.66 , 0.71 , 0.74 , 0.77 , 0.82 , 0.85 , 0.87 , 0.89 , 0.92 , 0.94 ]$$

If the calculated score is greater than a predefined threshold, the new quantization parameter QP is calculated and used for the next macroblock. The quantization parameter QP is left unchanged if the score is found below the predefined threshold.

The quantization parameter QP for the following macroblocks, the updated quantization parameter QP_{updated} is calculated using the following equation:

$${QP}_{updated} ( i ) = \{ \begin{matrix}{QP}_{original} + {Δ}_{1} , if {N}_{pred} ( i , {mb}_{curr} ) > upper\_limit ( i ) \\ {QP}_{original} + {Δ}_{2} , if center\_bit ( i ) < {N}_{pred} ( i , {mb}_{curr} ) < upper\_limit ( i ) \\ {QP}_{original} - {Δ}_{3} , if lower\_limit ( i ) < {N}_{pred} ( i , {mb}_{curr} ) < center\_bit ( i ) \\ {QP}_{original} - {Δ}_{4} , if {N}_{pred} ( i , {mb}_{curr} ) < lower\_limit ( i )\end{matrix} , \qquad Eq . ( 9 )$$

where Δ₁, Δ₂, Δ₃, and Δ₄ are (pre-defined) constant values, and their values could be (Δ₁, Δ₂, Δ₃, Δ₄ )=(2, 1, 1, 2), but it should be understood that their values are not limited thereto. In particular, different application scenarios may require other values for obtaining better results. Alternatively, the updated quantization parameter QP_{updated} may be calculated on the basis or in dependence of the score QP_{score} defined above.

It should be noted that the invention is not limited to the above presented embodiment of the present invention, which represents merely one implementation for the way of illustration. In particular, the bit adjust window length W of equation (1) might be chosen to be W=1, but the present invention is not limited thereto. Further, the initial quantization parameter QP for (“Inter”) P or B-frames can be calculated using a different method than that one presented in detail above. With reference to equation (6), another model may be used for (“Intra”) IDR-frames. With respect to equations (7.1) and (7.2), the pre-defined constants K and J may have assigned, but not limited, the values K=2 and J=4 respectively. Nevertheless the values of the pre-defined constants K and J may have different values. Moreover, the embodiment of the present invention is not limited to the implementation of the Bit-Predictor as described above but can be implemented in a different way than the embodiment presented. Those skilled in the art will also appreciate that the two quantization parameters QP are obtainable; i.e. a short window quantization parameter QP_{SW} and long window quantization parameter QP_{LW}, are not limited to the specific limitations and periods for calculation described above. Especially, the period for calculation of the QP_{LW} may be different. With reference to equation (8), it should also be noted that the score QP_{score} could be calculated by using a different model other than the model presented, which represents only one embodiment for the way of illustration. Moreover, the function ƒ(mb_{curr}), which is the function to account for unreliability of bit prediction at the starting macroblocks, should be understood as not being limited to the look-up table presented above. For instance, the function ƒ(mb_{curr}) is a parabolic function implementable on the basis of a look-up table.

Now, an overall bit rate control operation on the basis of an operational sequence according to an embodiment of the present invention will be described with reference to FIG. 3.

In operation S100, the encoding of a video input signal and the controlling of the bit rate of the output bitstream resulting from the encoding of the video input signal begins.

In operation S110, rate control parameters, which are required for rate control, are initialized. The rate control parameters requiring initialization include especially at least one out of the group of parameters including, but not limited, video bit rate R_{video}, frame rate ƒ, adjust window length W, window size of the short window rate distortion model SW_size, window size of the long window rate distortion model LW_size, QP_{LW} update repetition rate, rate distortion model parameters (a_{1,SW}, a_{2,SW}), (a_{1,LW}, a_{2,LW}), (initial) buffer fullness B_{fullness}, buffer size B_{size}, constants K and J for bit-envelope calculation for (“Inter”) P or B-frames, look-up table for ƒ(mb_{curr}) to account for unreliability of bit prediction.

In following operation S120, the initial frame quantization parameter QP is calculated. An embodiment allowing the calculation of the initial frame quantization parameter QP for (“Inter”) P or B-frames and initial frame quantization parameter QP for (“Intra”) IDR-frames has been illustrated above in detail, respectively.

Upon provision of the initial frame quantization parameter QP, the encoding of a current frame is started in operation S130. A first group of macroblocks of the frame is encoded in operation S150 and it is checked in operation S160 whether one or more further groups of macroblocks are present in the frame. In case there is at least one more group of macroblock the quantization parameter QP is adjusted for the next group of macroblocks in an operation S140. The adjustment of the quantization parameter QP is illustrated above in detail on the basis of an embodiment for way of illustration.

In case the last group of macroblock has been encoded, the operational sequence continues with operation S170, where it is checked whether the current encoded frame requires re-encoding. A re-encoding may be required in case that the adjustment of the quantization parameter QP has been not successfully and the bit rate of the resulting encoded video bitstream is not acceptable, for instance if the resulting bit rate is above or below a threshold. In case required re-encoding, the operational sequence continues with a calculation of an updated initial frame quantization parameter QP in operation S180 and returns to operation S130, where the encoding of the current frame is re-started.

Otherwise, i.e. in case of a successful encoding of the frame, it is finally checked whether the video encoding is completed. In case the last frame has been encoded, the encoding of a video input signal and the controlling of the bit rate of the output bitstream ends in operation S200. In case there are still frames available for encoding, the operational sequence returns to operation S110, repeating the processing with a new frame next in sequence.

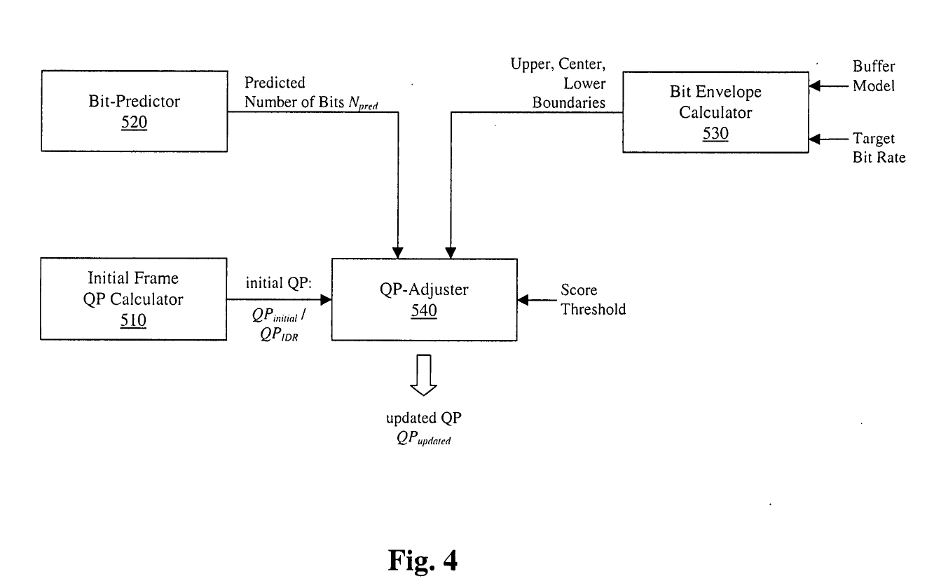

With reference to FIG. 4, a block diagram is shown, which illustrates components of the rate controller arranged for performing the above illustrated operational sequence according to an embodiment of the present invention.

The rate controller comprises an initial quantization parameter QP calculator 510, a Bit Envelope Calculator 530, a Bit-Predictor 520 and a QP-Adjuster 540.

The QP-Initializer or initial quantization parameter QP calculator 510 is arranged to provide the initial quantization parameter QP. The quantization parameter QP has to be initialized upon start of the encoding of the video sequence. An initial value of the quantization parameter QP may be provided by input preferably manually, but also on the basis of an estimation and calculation, respectively. The estimation or calculation is obtainable on the basis of one or more predefined parameters and constrictions including at least one or more parameters/and or constrictions comprising a demanded bit rate or a desired target bit rate of the encoded bitstream, a frame rate of the encoded video sequence carried by the bitstream, and a buffer model.

Any typical compliant video decoder is equipped with a buffer storage enabling to balance variations in the rate and arrival time of incoming data packets of a video sequence. Hence, the video encoder has to encode a video bitstream that satisfies constraints of the decoder, especially constraints relating to the buffer storage. A so-called virtual buffer model is applicable to predict the fullness of the buffer storage of the video decoder. The change in fullness of the virtual buffer is in general the difference between the total bits encoded into the bitstream of the video sequence less a demanded bit rate of the bitstream. In principle, the buffer fullness is bounded by minimal buffer capacity, which is equal to zero, from below and by the maximal capacity from above. The rate control mechanism has to be provided with appropriate values for buffer capacity and initial buffer fullness, which are consistent with the video decoder.

According to an embodiment of the present invention, different initial QP calculation mechanisms for “Inter”-frames and “Intra”-frames are illustratively described above.

The initial QP calculation mechanism for “Inter”-frames is applicable to obtain an initial quantization parameter QPᵢₙᵢₜᵢₐₗ on the basis of two quantization parameters including a (short window) quantization parameter QP_{SW} determined in accordance with a short window rate distortion model and a (long window) quantization parameter QP_{LW} determined in accordance with a long window rate distortion model and in dependence of a buffer fullness ratio γ determined in accordance with a virtual buffer model. The definitions short window and long window each relate to specific (pre-defined) repetition periods for calculation of the respective short and long quantization parameters QP_{SW}, QP_{LW}, respectively. In more detail, the initial quantization parameter QPᵢₙᵢₜᵢₐₗ is obtainable from either an average quantization parameter of the quantization parameters of a number of previous frames and pre-defined (positive or negative) quantization parameter offsets, a weighted average of the short and long window quantization parameters QP_{SW} and QP_{LW}, or the long quantization parameter QP_{LW}.

The buffer fullness ratio γ is a function of at least one parameter out of the group comprising buffer occupancy at the time of encoding the current frame, buffer size, video bit rate, frame bit rate, and the number of consecutive frame skips that happened before encoding the current frame.

The initial QP calculation mechanism for “Intra”-frames is applicable to obtain an initial quantization parameter QP_{IDR} on the basis of linear regression and pre-defined constants. The linear regression is calculated from L numbers of bits N_{bits,IDR}[ . . . ], which have been generated for the encoding of the last L pictures/frames, and L quantization parameters QP_{IDR}[ . . . ] defined for the encoding of these last L pictures/frames.

In case the linear regression is not applicable, the quantization parameter QP_{IDR} may be obtainable from a minimum value, a maximum value, or one or more last quantization parameters QP_{IDR} offset by one or more predefined offset values (e.g. −1, ±0, and +1). The minimum and/or maximum values may be predefined value(s) or may be determined from a selection of quantization parameters QP_{IDR}[ . . . ] defined for the encoding a number of previous pictures/frames.

According to an embodiment of the present invention, the Bit-Envelope Calculation illustratively described above is operable with the Bit Envelope Calculator 530. The Bit Envelope Calculator 530 is arranged to determine bit envelope values for frames to be encoded. The envelope values comprise at least an upper limit (upper_limit) and a lower limit (lower_limit), which define the maximum and minimum number of bits allowed to be generated by the video encoding. A further center value (centerBit) may define the desired number of bits for the frame to be achieved by video encoding. In general, the Bit-Envelope Calculation is based on, but not limited, a buffer model to simulate the number of bits available in the decoder during decoding. Additionally, video bit rate (R_{video}), target video bit rate (R_{target}) and/or video frame rate (ƒ) may be taken into account.

According to an embodiment of the present invention, the Bit-Prediction illustratively described above is operable with the Bit Predictor 520. The Bit-Predictor 520 is arranged to predict the number of bits (Npred) that will be generated for the frame and its macroblocks, before the encoding of the frame is completed. Therefore, the Bit Predictor is adapted to predict the number of bits that will be generated for the frame and its macroblocks on the basis of the number of bits, which have been generated for one or more previous macroblocks of the current frame, one or more previous frames, and/or one or more macroblocks of previous frames. In general, for (“Inter”) P- or B-frames, the prediction of the number of bits is obtained from a bit distribution of current and previous frames. For (“Intra”) IDR-frames, the number of bits, which have been generated at the previous frame, is used.

According to an embodiment of the present invention, the QP-Adjustment illustratively described above is operable with the QP-Adjuster 540. The QP-Adjuster 540 is arranged to adjust the quantization parameter QP at the macroblock level. Before adjustment, an update threshold relating to the adjustment frequency is check to limit the occurrence of an adjustment process to a desired rate. Based on a score value, which depends on the bit envelope values and the predicted number of bits for the frame and its macroblocks, it is decided whether to update the currently used quantization parameter QP or not. In case the score value exceeds a predefined threshold, the currently used quantization parameter QP is adjusted. The adjustment is preferably performed on the basis of one or more offset values, which have predefined values depending on the envelope values (upper_limit, lower_limit, centerBit) and the predicted number of bits (N_{pred}). For example, the offset values may be 2, 1, −1, and −2 depending of the relationship between the envelope values (upper_limit, lower_limit, centerBit) and the predicted number of bits (N_{pred}).

The present invention is described in the general context of operations, which may be implemented in one embodiment by a program product including computer-executable instructions, such as code sections and program code, executed by computers in networked environments. Generally, program modules include routines, programs, objects, components, data structures etc. that perform particular tasks or implement particular abstract data types. Computer-executable instructions, associated data structures, and program modules represent examples of program code for executing operations of the methods disclosed herein. The particular sequence of such executable instructions or associated data structures represents examples of corresponding acts for implementing the functions described in such steps.

Software implementations of the present invention could be accomplished with standard programming techniques with rule based logic and other logic to accomplish the various database searching operations, correlation operations, comparison operations and decision operations. It should also be noted that the words “component” and “module”, as used herein and in the claims, is intended to encompass implementations using one or more lines of software code, and/or hardware implementations, and/or equipment for receiving manual inputs.

The foregoing description of embodiments of the present invention has been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated. All such changes, modifications, variations and other uses and applications which do not depart from the spirit and scope of the invention are deemed to be covered by the invention.

1. Method of rate control for a video encoder, comprising:
performing a frame encoding process for each frame including:
determining an initial quantization parameter for being used as a quantization parameter for encoding a current frame; and
encoding groups of macroblocks within the current frame, wherein said macroblock encoding process for group of macroblocks includes:
determining a score value after encoding of a current group of macroblocks;
if the score value exceeds a pre-defined threshold, adjusting the quantization parameter for encoding a next group of macroblocks; and
otherwise, continuing macroblock encoding with the quantization parameter currently valid.

2. Method according to claim 1, wherein said score value is determined on the basis of at least one out of the group comprising one or more bit envelope values for the current frame, a predictive number of bits, which predicts a number of bits required for encoding the current macroblock at the time of encoding, and a macroblock index.

3. Method according to claim 1, wherein the predictive number of bits is determined on the basis of number of bits generated for encoding one or more previous macroblocks of the current frame and/or one or more one or more previous macroblocks of one or more previous frames.

4. Method according to claim 2, comprising:
determining the bit envelope values for the current frame, which bit envelope values include at least an upper limit and a lower limit, wherein the envelope values are determined in accordance with a buffer model and/or are based on at least one value out of the group comprising a video bit rate, a target number of bits for the current frame and a video frame rate; and
determining said score value on the basis of the predictive number of bits, the envelope values, and a pre-defined function to account for unreliability of the bit prediction, which is a function of said macroblock index, wherein said pre-defined function is preferably a parabolic function implementable on the basis of a look-up table.

5. Method according to claim 1, wherein the adjusting of the quantization parameter comprises offsetting the quantization parameter by at least one offset value; wherein the at least one offset value is dependent on the envelope values and/or the determined predictive number of bits.

6. Method according to claim 1, wherein the adjusting of the quantization parameter is performed in dependence of the score value.

7. Method according to claim 1, comprising:
initializing at least one rate control-related parameter; wherein the at least one rate control-related parameter is selected from the group consisting of bit rate and buffer size.

8. Method according to claim 1, comprising:
determining a number of macroblocks, which have been encoded since the last quantization parameter adjustment has took place; and
in case the number of macroblock exceeds a pre-defined threshold, allowing for adjusting the quantization parameter.

9. Method according to claim 1, comprising:
if necessary, determining an updated initial quantization parameter for the current frame and repeating the encoding process.

10. Method according to claim 1, wherein further comprising determining whether the current frame is a P frame or an ideal data representation frame.

11. Method according to claim 10, wherein if the current frame is a P-frame, the predictive number of bits is determined from a bit distribution of one or more previous frames.

12. Method according to claim 10, wherein if the current frame is an ideal data representation frame, the predictive number of bits is determined from the number of bits generated at a previous frame.

13. Method according to claim 10, wherein if the current frame is a P frame, the initial quantization parameter is calculated by:
calculating values for short window and long window quantization parameters;
calculating the initial quantization parameter based upon the short window and long window quantization parameters; and/or
clipping the value for the frame's initial quantization parameter.

14. Method according to claim 10, wherein if the current frame is an ideal data representation frame, the initial quantization parameter is calculated by:
if a buffer availability check in accordance with the buffer model is successful, employing a quantization parameter of the previous P-frame as the initial quantization parameter;
if the buffer availability check fails, extrapolating the initial quantization parameter from the number of bits generated for one or more previous frames and the quantization parameters used for encoding the one or more previous frames and clipping the extrapolated quantization parameter, wherein the extrapolation is based on a regression calculation on the basis of a regression function having one or more parameters; and/or
if the extrapolation is not reliable, determining the initial quantization parameter from one or more quantization parameters of one or more previous ideal data representation frames.

15. Computer program product for provision of rate control for a video encoder, comprising:
program section for performing a frame encoding process for each frame including:
program section for determining an initial quantization parameter for being used as a quantization parameter for encoding a current frame; and
program section for encoding groups of macroblocks within the current frame, wherein for group of macroblocks the program section for macroblock encoding includes:
program section for determining a score value after encoding of a current macroblock;
if the score value exceeds a pre-defined threshold, program section for adjusting the quantization parameter for encoding a next group of macroblocks; and
otherwise, program section for continuing macroblock encoding with the quantization parameter currently valid.

16. Computer program product according to claim 15, wherein said score value is determined on the basis of at least one out of the group comprising one or more bit envelope values for the current frame, a predictive number of bits, which predicts a number of bits required for encoding the current macroblock at the time of encoding, and a macroblock index.

17. Computer program product according to claim 15, wherein the predictive number of bits is determined on the basis of number of bits generated for encoding one or more previous macroblocks of the current frame and/or one or more one or more previous macroblocks of one or more previous frames

18. Computer program product according to claim 16, comprising:
program section for determining the bit envelope values for the current frame, which bit envelope values include at least an upper limit and a lower limit, wherein the envelope values are determined in accordance with a buffer model and/or are based on at least one value out of the group comprising a video bit rate, a target number of bits for the current frame and a video frame rate; and
program section for determining the score value on the basis of the predictive number of bits, the envelope values, and a pre-defined function to account for unreliability of the bit prediction, which is a function of the macroblock index, wherein the pre-defined function is preferably a parabolic function implementable on the basis of a look-up table.

19. Computer program product according to claim 15, wherein the program section for adjusting of the quantization parameter comprises program section for offsetting the quantization parameter by at least one offset value; wherein the at least one offset value is dependent on the envelope values and/or the determined predictive number of bits.

20. Computer program product according to claim 15, wherein the program section for adjusting of the quantization parameter is arranged to determine the quantization parameter in dependence of the score value.

21. Computer program product according to claim 15, comprising:
program section for initializing at least one rate control-related parameter; and wherein the at least one rate control-related parameter is selected from the group consisting of bit rate and buffer size.

22. Computer program product according to claim 15, comprising:
program section for determining a number of macroblocks, which have been encoded since the last quantization parameter adjustment has took place; and
in case the number of macroblock exceeds a pre-defined threshold, allowing for adjusting the quantization parameter.

23. Computer program product according to claim 15, comprising:
if necessary, program section for calculating an updated initial quantization parameter for the current frame and repeating the frame encoding process.

24. Computer program product according to claim 15, wherein further comprising program section for determining whether the current frame is a P frame or an ideal data representation frame.

25. Computer program product according to claim 23, wherein if the current frame is a P-frame, the predictive number of bits is determined from a bit distribution of one or more previous frames.

26. Computer program product according to claim 23, wherein if the current frame is an ideal data representation frame, the predictive number of bits is determined from the number of bits generated at a previous frame.

27. Computer program product according to claim 23, wherein if the current frame is a P frame, the initial quantization parameter is calculated by:
program section for calculating values for short window and long window quantization parameters;
program section for calculating the initial quantization parameter based upon the short window and long window quantization parameters;
program section for clipping the value for the frame's initial quantization parameter.

28. Computer program product according to claim 23, wherein if the current frame is an ideal data representation frame, the program section for initial quantization parameter comprises:
if a buffer availability check in accordance with the buffer model is successful, program section for employing a quantization parameter of the previous P-frame as the initial quantization parameter;
if the buffer availability check fails, program section for extrapolating the initial quantization parameter from the number of bits generated for one or more previous frames and the quantization parameters used for encoding the one or more previous frames and clipping the extrapolated quantization parameter, wherein the extrapolation is based on a regression calculation on the basis of a regression function having one or more parameters; and
if the extrapolation is not reliable, program section for determining the initial quantization parameter from one or more quantization parameters of one or more previous ideal data representation frames.

29. Electronic device, comprising:
a processor;
a memory unit operatively connected to the processor and including a computer program product for provision of rate control for a video encoder, comprising:
program section for performing a frame encoding process for each frame including:
program section for determining an initial quantization parameter for being used as a quantization parameter for encoding a current frame; and
program section for encoding groups of macroblocks within the current frame, wherein for group of macroblocks the program section for macroblock encoding includes:
program section for determining a score value after encoding of a current macroblock;
if the score value exceeds a pre-defined threshold, program section for adjusting the quantization parameter for encoding a next group of macroblocks; and
otherwise, program section for continuing macroblock encoding with the quantization parameter currently valid.

30. Electronic device according to claim 29, wherein said score value is determined on the basis of at least one out of the group comprising one or more bit envelope values for the current frame, a predictive number of bits, which predicts a number of bits required for encoding the current macroblock at the time of encoding, and a macroblock index.

31. Electronic device according to claim 29, wherein the predictive number of bits is determined on the basis of number of bits generated for encoding one or more previous macroblocks of the current frame and/or one or more one or more previous macroblocks of one or more previous frames.

32. Electronic device according to claim 30, comprising:
program section for determining the bit envelope values for the current frame, which bit envelope values include at least an upper limit and a lower limit, wherein the envelope values are determined in accordance with a buffer model and/or are based on at least one value out of the group comprising a video bit rate, a target number of bits for the current frame and a video frame rate; and
program section for determining the score value on the basis of the predictive number of bits, the envelope values, and a pre-defined function to account for unreliability of the bit prediction, which is a function of the macroblock index, wherein the pre-defined function is preferably a parabolic function implementable on the basis of a look-up table.

33. Electronic device according to claim 29, wherein the program section for adjusting of the quantization parameter comprises program section for offsetting the quantization parameter by at least one offset value; wherein the at least one offset value is dependent on the envelope values and/or the determined predictive number of bits.

34. Electronic device according to claim 29, wherein the program section for adjusting of the quantization parameter is arranged to determine the quantization parameter in dependence of the score value.

35. Electronic device according to claim 29, comprising:
program section for initializing at least one rate control-related parameter; and wherein the at least one rate control-related parameter is selected from the group consisting of bit rate and buffer size.

36. Electronic device according to claim 29, comprising:
program section for determining a number of macroblocks, which have been encoded since the last quantization parameter adjustment has take place; and
in case the number of macroblock exceeds a pre-defined threshold, allowing for adjusting the quantization parameter.

37. Electronic device according to claim 29, comprising:
if necessary, program section for calculating an updated initial quantization parameter for the frame and repeating the encoding process for the frame.

38. Electronic device according to claim 29, wherein further comprising program section for determining whether the current frame is a P frame or an ideal data representation frame.

39. Electronic device according to claim 38, wherein if the current frame is a P-frame, the predictive number of bits is determined from a bit distribution of one or more previous frames.

40. Electronic device according to claim 38, wherein if the current frame is an ideal data representation frame, the predictive number of bits is determined from the number of bits generated at a previous frame.

41. Electronic device according to claim 38, wherein if the current frame is a P frame, the initial quantization parameter is calculated by:
program section for calculating values for short window and long window quantization parameters;
program section for calculating the initial quantization parameter based upon the short window and long window quantization parameters;
program section for clipping the value for the frame's initial quantization parameter.

42. Electronic device according to claim 38, wherein if the current frame is an ideal data representation frame, the program section for initial quantization parameter comprises:
if a buffer availability check in accordance with the buffer model is successful, program section for employing a quantization parameter of the previous P-frame as the initial quantization parameter;
if the buffer availability check fails, program section for extrapolating the initial quantization parameter from the number of bits generated for one or more previous frames and the quantization parameters used for encoding the one or more previous frames and clipping the extrapolated quantization parameter, wherein the extrapolation is based on a regression calculation on the basis of a regression function having one or more parameters; and
if the extrapolation is not reliable, program section for determining the initial quantization parameter from one or more quantization parameters of one or more previous ideal data representation frames.

43. Video encoder operable with rate control module,
wherein said video encoder is arranged to perform frame encoding for each frame including:
an initial frame QP calculator arranged for determining an initial quantization parameter for being used as a quantization parameter for encoding a current frame; and
wherein said video encoder is arranged for macroblock encoding of group of macroblocks within a current frame including:
a QP adjuster arranged for determining a score value after encoding of a current group of macroblocks of the current frame to be encoded, wherein said QP adjuster is adapted to adjust the quantization parameter for encoding a next group of macroblocks in case the score value exceeds a pre-defined threshold and otherwise to maintain the currently valid quantization parameter for macroblock encoding.

44. Video encoder according to claim 43, including
the QP adjuster arranged for determining said score value on the basis of at least one out of the group comprising one or more bit envelope values for the current frame, a predictive number of bits, which predicts a number of bits required for encoding the current macroblock at the time of encoding, and a macroblock index.

45. Video encoder according to claim 43, including
a bit predictor arranged for determining the predictive number of bits on the basis of number of bits generated for encoding one or more previous macroblocks of the current frame and/or one or more one or more previous macroblocks of one or more previous frames.

46. Video encoder according to claim 44, comprising:
a bit envelope calculator arranged for determining the bit envelope values for the current frame, which bit envelope values include at least an upper limit and a lower limit, wherein the envelope values are determined in accordance with a buffer model and/or are based on at least one value out of the group comprising a video bit rate, a target number of bits for the current frame and a video frame rate; and
the QP adjuster arranged for determining said score value on the basis of the predictive number of bits, the envelope values, and a pre-defined function to account for unreliability of the bit prediction, which is a function of said macroblock index, wherein said pre-defined function is preferably a parabolic function implementable on the basis of a look-up table.

47. Video encoder according to claim 43, wherein the QP adjuster is arranged for adjusting the quantization parameter in that the quantization parameter is offset by at least one offset value; wherein the at least one offset value is dependent on the envelope values and/or the determined predictive number of bits.

48. Video encoder according to claim 43, wherein the QP adjuster is arranged for adjusting the quantization parameter in dependence of the score value.

49. Video encoder according to claim 43, comprising:
at least one rate control-related parameter;
wherein the at least one rate control-related parameter is selected from the group consisting of bit rate and buffer size.

50. Video encoder according to claim 43, including:
the QP adjuster arranged for determining a number of macroblocks, which have been encoded since the last quantization parameter adjustment has took place and in case the number of macroblock exceeds a pre-defined threshold, allowing for quantization parameter adjustment.

51. Video encoder according to claim 43, including:
the initial frame QP calculator arranged for determining an updated initial quantization parameter for the current frame and initiating repetition of the frame encoding process, if necessary.

52. Video encoder according to claim 43, wherein further comprising determining whether the current frame is a P frame or an ideal data representation frame.

53. Video encoder according to claim 52, wherein if the current frame is a P-frame, the bit predictor is arranged for determining the predictive number of bits from a bit distribution of one or more previous frames.

54. Video encoder according to claim 52, wherein if the current frame is an ideal data representation frame, the bit predictor is arranged for determining the predictive number of bits from the number of bits generated at a previous frame.

55. Video encoder according to claim 52, wherein if the current frame is a P frame, the initial frame QP calculator arranged for:
calculating values for short window and long window quantization parameters;
calculating the initial quantization parameter based upon the short window and long window quantization parameters; and/or
clipping the value for the frame's initial quantization parameter.

56. Video encoder according to claim 52, wherein if the current frame is an ideal data representation frame, the initial frame QP calculator arranged for:
if a buffer availability check in accordance with the buffer model is successful, employing a quantization parameter of the previous P-frame as the initial quantization parameter;
if the buffer availability check fails, extrapolating the initial quantization parameter from the number of bits generated for one or more previous frames and the quantization parameters used for encoding the one or more previous frames and clipping the extrapolated quantization parameter, wherein the extrapolation is based on a regression calculation on the basis of a regression function having one or more parameters; and/or
if the extrapolation is not reliable, determining the initial quantization parameter from one or more quantization parameters of one or more previous ideal data representation frames.
